(19) United States
(12) Patent Application Publication
(10) Pub. No.: US 2018/0333654 A1
(43) Pub. Date: Nov. 22, 2018

(54) Fluid Treatment System and Method of Use Utilizing a Membrane

(71) Applicant: Jarid Hugonin, Lafayette, LA (US)

(72) Inventor: Jarid Hugonin, Lafayette, LA (US)

(21) Appl. No.: 15/600,235

(22) Filed: May 19, 2017

(51) Int. Cl. B01D 17/02; B01D 21/00; F04B 43/00; B01D 21/26; B01D 63/00

(52) U.S. Cl. CPC B01D 17/0202; B01D 17/0214; B01D 21/0012; B01D 63/005; B01D 21/26; B01D 21/267; F04B 43/0009

(57) ABSTRACT

A variable oil field fluid treatment system and method of use which utilizes a pump, a desanding hydrocydone, and or a non-consumable or consumable mechanical solids filter, a membrane unit, a pump and/or combinations therein.

### BACKGROUND

The present invention generally relates, to the treatment of well fluids, and oilfield waste water. Relevant background information is discussed below,

The U.S. Environmental Protection Agency (EPA) generally defines an injection well as a bored, drilled, or driven shaft, or a dug hole that is deeper than it is wide, or an improved sinkhole, or a subsurface fluid distribution system. Well construction depends on the injection fluid injected to the depth of the injection zone. Deep wells that are designed to inject hazardous wastes or carbon dioxide deep below the Earth's surface have multiple layers of protective easing and cement, Whereas shallow wells injecting non-hazardous fluids into or above drinking water sources are more simply constructed.

In some waste water disposals, treated waste water is injected into the ground between impermeable layers of rocks to avoid polluting fresh water supplies or adversely affecting the quality of receiving waters. Injection wells are usually constructed of solid walled pipe to a deep elevation in order to prevent injectate from mixing with the surrounding environment.

Injection wells can be considered to be one method for disposal of treated waste water. Unlike outfalls, or other direct disposal techniques, injection wells utilize the Earth as a filter to further clean the treated wastewater before it reaches the receiving water. This method of waste water disposal also serves, to spread the injectate over a wide, area, further decreasing environmental impacts.

There are, in general, disposals for well injections on platforms at sea, and on land, when water does not meet customer specifications. Some of these waters are disposed to a boat which transports the materials to land for treatment and disposal. Some companies dispose to tanks on platforms, then transport, treat and dispose of the water on land. In other variations, there are pumps used to pump well injections into pipelines for transport to salt caverns, on land.

Salt caverns are cavities, or chambers, formed in underground salt deposits. Although cavities may naturally form in salt deposits, some caverns are intentionally created by humans for specific purposes, such as for storage of petroleum products or disposal of wastes.

Some removal solutions involve treatment with absorption technologies for discharge overboard from the platform. Some utilize hydrocyclones as well, or utilize both technologies in treatment procedures. Some systems treat with coalescing technologies for discharge overboard. Some systems treat with diatomaceous earth technologies. Some systems utilize centrifuge and/or absorption or coalescing: technologies. Some removal solutions use conventional solids filtration. Some removal solutions utilize diffused gas flotation or induced gas flotation technologies.

Within some water-treatment equipment, in which, the energy input to the fluid is very small, the process of coalescence takes place; that is, small oil droplets collide and form bigger droplets. Because of the low energy input, these droplets are not dispersed. Coalescence can also occur in the pipe downstream of pumps and control valves; if enough residence time is given. However, in such instances, the process of dispersion will govern the maximum size of stable oil droplets that can exist. For normal pipe diameters and flow velocities, particles of 500 to 5000 μm are possible.

A centrifugal water-oil separator, centrifugal oil-water separator or centrifugal liquid-liquid separator is a device designed to separate oil and water by centrifugation. It generally contains a cylindrical container that rotates inside a larger stationary container. The denser liquid, usually water, accumulates at the periphery of the rotating container and is collected from the side of the device, whereas the less dense liquid, usually oil, accumulates at the rotation axis and is collected from the center.

Conventional technologies involved with water treatment often remove and contain oil and grease which utilize expensive chemicals or consumable medias that, requires disposal on land. These consumable media technologies become cost prohibitive as they consume the oil to be removed and still require further disposal. Traditional oil absorbing media needs to be disposed once it is utilized, as it becomes a waste product.

### SLOP WATER BACKGROUND

Produced water that does not meet discharge or injection criteria diverted into oil storage tanks on FPSO is typically called “slop water”. A Floating Production, Storage and Offloading (“FPSO”) unit is a floating vessel used by the offshore oil and gas industry for the production and processing of hydrocarbons, and for the storage of oil. A FPSO vessel is designed to receive hydrocarbons produced by itself, or from nearby platforms, or subsea template, process them, and store oil until it can be offloaded onto a tanker or, less frequently, transported through a pipeline. FPSOs are preferred in frontier offshore regions as they are easy to install, and do not require a local pipeline infrastructure to export oil FPSOs can be a converted oil tanker or can be a vessel built specially for the application.

Slop waters are generated from off specification produced water not suitable for overboard discharge and oily water skimmings from flotation technologies and hydro cyclone rejects. Skimmings, or reject, are a percentage of the fluid that is not sent out of the discharge of the equipment, but is recycled, back into the front of the total process. The reject is mostly water so it will, be recycled back into the total system further upstream.

Slop water can be stored in the compartments within the hull of the ship for days, weeks, months or even years. During this timeframe, chemicals are added to control corrosion, bacteria and H₂S content of the slop water; this causes emulsions to be formed due to the fine solids generated in this treatment. Due to these emulsions, hydrocarbons will not typically be separated from the slop water by gravity separation.

Increased volumes of slop water in tanks reduces the oil storage capacity of these facilities significantly, affecting the economics of an operation. Since the same storage tanks that are design to hold bulk oil will also hold slop water, the more slop water that is in the tanks, the less amount of slop water can be stored. Once the storage tanks are full, whether it is with slop water or oil, the oil will need to be off-loaded.

### DECK DRAINAGE WATER BACKGROUND

Deck drainage water, in oil and/or gas drilling and production, comes from collected rainwater and miscellaneous fluids such as oils and greases on a deck of a platform . Typically, a number of drains are spread throughout one or more decks of the offshore platform, especially on portions of the decks which are open and therefore exposed to the weather. Since the rainwater washes any spilled oil or grease off of the deck and into the drains, the rainwater cannot be passed directly into the body of water beneath the platform. Instead, the collected rainwater must be treated so as to separate the oil from the water until the percentage of oil in the water reaches an acceptable level.

Presently, laws, such as the Clean Water Act, prohibits discharging “pollutants” through a “point source” into a “water of the United States” unless they have an NPDES permit. The permit will contain limits on. what an entity can discharge, monitoring and reporting requirements, and other provisions to ensure that the discharge does not hurt water quality or people's health. In essence, the permit translates general requirements of the Clean Water Act into specific provisions tailored to the operations of each person discharging pollutants. Typically (as the governing country's ordinances permit), as little as twenty-nine parts per million of oil in water is permitted in the water to be returned to the body of water beneath the platform (in some areas of the world it is 15 ppm).

### POLYMER FLOOD BACKGROUND

After primary and secondary recovery (below), chemical enhanced oil recovery technology can extract almost 20% of additional oil from a reservoir. Polymer flooding is an established chemical enhanced oil recovery process, where an aqueous polymeric solution with a viscosity closely matched to the oil is injected to enhance the mobility of fluid .in the reservoir. The fluid injection profile is improved through the addition of polymers, making it more consistent and stable, enhancing the displacement efficiency,

During the primary recovery stage, reservoir drive comes from a number of natural mechanisms. These include: natural water displacing oil downward into the well, expansion of the natural gas at the top of the reservoir, expansion of gas initially dissolved in the crude oil, and gravity drainage resulting from the movement of oil within the reservoir from the upper to the lower parts where the wells are located.

When underground pressure in the oil reservoir is sufficient to force the oil to the surface, ail that is necessary is to place a complex arrangement, of valves on the well head to connect the well to a pipeline network for storage and processing. Sometimes pumps, such as beam pumps and electrical submersible pumps (ESPs), are used to bring the oil to the surface; these are known as artificial lifting mechanisms.

Over the lifetime of the well, the pressure tails and at some point, there is insufficient underground pressure to force the oil to the surface. After natural reservoir drive diminishes, secondary recovery methods are applied. Secondary recovery methods can rely on the supply of external energy into the reservoir in the form of injecting fluids to increase reservoir pressure, hence replacing or increasing the natural reservoir drive with an artificial drive. Secondary recovery techniques increase the reservoir's pressure by water injection, natural gas reinjection and gas lift, which injects air, carbon dioxide or some other gas into the bottom of an active well, reducing the overall density of fluid in the wellbore.

The performance of the polymeric solutions used largely relies on their theological properties and therefore, detailed rheological characterization under relevant conditions supports performance optimization, in addition to the polymers, surfactants can also be added to add additional extraction capabilities. Polymer flooding will increase the viscosity of the water and surfactants will create a tighter oil water emulsion, while the water returning to the surface will be difficult for standard water treatment equipment to maintain efficiencies in recapture.

### ACID STIMULATION BACKGROUND

Oil and gas operators may use acid treatment (acidizing) to improve well productivity. The assortment of drilling -fluid pumped down the well during drilling and completion can often cause damage to the surrounding formation by entering the reservoir rock and blocking the pore throats. Similarly, the act of perforating can have a similar effect by jetting debris into the perforation channels. Both these situations reduce the permeability in the near well bore area and so reduce the flow of fluids into the well bore.

One solution is to pump diluted acid mixtures from surface into the well to dissolve the offending material. Once dissolved, permeability should be restored and the reservoir fluids will flow into the well bore, cleaning up what is left of the damaging material After initial completion, it is common to use minimal amounts of formic acid to clean up any mud and skin damage, in this situation, the process is loosely referred to as “well stimulation.”

In some instances, pumping from the surface is insufficient as it does not target any particular location downhole and reduces the chances of the chemical retaining its effectiveness when it gets to its intended location. In these cases, it is necessary to spot the chemical directly at its target through the use of coiled tubing. Coiled tubing is run in hole with a jetting tool on the end. When the tool is at its target, the chemical is pumped through the pipe and is jetted directly onto the damaged area.

The development of effective corrosion inhibitors and the use and further development of acid treatment (acidizing) of oil and gas wells proliferated and lead to the establishment of the well stimulation services industry.

Acid washing is most commonly performed with hydrochloric acid (HCl) mixtures but other acids can be used to clean out scale (such as calcium carbonate), rust, and other debris restricting flow in the well. Matrix and fracture acidizing are both formation treatments. The acid treatment is injected, below the formation fracturing pressure. In fracture acidizing, acid is pumped above the formation fracturing pressure. The purpose of fracture acidizing, is to restore or Improve an oil or gas well's productivity by dissolving material in the productive formation that, is restricting oil and water flow, or to dissolve the formation rock itself to enhance existing flow paths, or to create new oil and water flow paths to the wellbore.

### COMPLETION FLUIDS BACKGROUND

There are applications in which a solids-free liquid is used to “complete” an oil or gas well. In these applications, the fluid is placed in the well to facilitate final operations prior to initiation of production. The fluid is meant to control a wellbore pressure should downhole hardware fail, without damaging the producing formation or completion components.

Completion fluids are typically brines (chlorides, bromides and formates), but in theory could be any fluid of proper density and flow characteristics. The fluid should be chemically compatible with the reservoir formation and fluids, and is typically filtered to a high degree to avoid introducing solids to the near-wellbore area. Seldom is a regular drilling fluid suitable for completion operations due to its solids content, pH and ionic composition.

Sometimes brine will be lost to the formation if the hydrostatic pressure of the brine is higher than the well bore pressure. If the weight of the brine has a higher hydrostatic pressure compared to the wellbore pressure, the brine will go into the formation. If the wellbore pressure is higher than the hydrostatic pressure of the brine, the well fluids will move upward towards the surface. Additives can be added to the brine to reduce or stop the fluid losses. When brine and additives return to surface facility, where separation equipment is needed to remove the hydrocarbons from the brine prior to discharging the water into the sea or injecting it into the well.

### PRODUCED OIL WET SOLIDS REMOVAL

Fine solid particles present in crude oil are capable of effectively stabilizing emulsions. The effectiveness of these solids in stabilizing emulsions depends on factors such as: solid particle size, interparticle interaction, and wettability of the solids.

Solid particles stabilize emulsions by diffusing to the oil/water interface, where they form rigid films that can sterically inhibit the coalescence of emulsion droplets. Furthermore, solid particles at the interface may be electrically charged, which may also enhance the stability of the emulsion. Particles must be much smaller than the size of the emulsion droplets to act as emulsion stabilizers. Typically, these solid particles are submicron to a few microns in diameter.

The wettability of the particles plays an important role in emulsion stabilization. Wettability is the degree to which a solid is wetted by oil or water when both are present. If the solid remains entirely in the oil or water phase, it will not be an emulsion stabilizer. For the solid to act as an emulsion stabilizer, it must be present at the interface and must be wetted by both the oil and water phases, in general, oil-wet solids stabilize a water-in-oil emulsion. Oil-wet particles preferentially partition into the oil phase and prevent the coalescence of water droplets by steric hindrance. Similarly, water-wet solids stabilize a water-continuous or an oil-in-water emulsion.

When solids are wetted by the oil and water (intermediate wettability), they agglomerate at the interface and retard coalescence. These particles must be repositioned into either the oil or water for coalescence to take place. This process requires energy and provides a barrier to coalescence.

The effectiveness of colloidal particles in stabilizing emulsions depends largely on the formation of a densely-packed layer of solid particles (film) at the oil/water interface. This film provides steric hindrance to the coalescence of water droplets. The presence of solids at the interface also changes the theological properties of the interface that exhibits viscoelastic behavior. This, affects the rate of film drainage between droplets and also affects the displacement of particles at the interface. It has also been demonstrated that for asphaltenes and waxes to be effective emulsifiers, they must be present in the form of finely divided submicron particles.

### SUMMARY

In some embodiments of the present invention, the present invention is a system and method for treatment of oil & gas production fluids utilizing a membrane. In some embodiments, the present invention treats fluids to satisfy customer and regulatory limits for overboard disposal, discharge to environment on land, transported to water treatment facility on land, or waste disposal through well injection. In some embodiments, the present process will successfully meet overboard disposal or injection well requirements with varying contamination levels of oil & grease (free and emulsified) and suspended solids. In some embodiments, the present process carbon footprint for similar flowrates is significantly lower than conventional technologies such as water skimmers, bulk oil treaters, liquid-liquid hydrocyclones, flotation vessels and absorption medias. In some embodiments, the present process utilizes minimal and often zero consumables compared to conventional technologies.

In some embodiments, the present invention is a system for acid and completion treatment comprising: a multicompartment or single compartment separator capable of treatment for separation with an intake valve, a pump; a hydrocyclone desander capable of desanding; and or a non-consumable or consumable mechanical solids filter capable of mechanical filtration; and a membrane unit is a membrane unit with a polymeric membrane filter; wherein fluid passed into said multicompartment or single compartment separator enters through said intake valve and gravity separation for bulk oil, gas and solids separation; said fluid is then capable of being pumped via said pump to either said hydrocyclone desander for desanding and or said non-consumable or consumable mechanical solids filter for mechanical filtration; said fluid is then passed into said membrane unit is a membrane unit with a polymeric membrane filter; and wherein water derived from said passing Into said multicompartment or single compartment separator enters through said intake valve and gravity separation for oil gas and solids separation; said fluid is then capable of being pumped via said pump to either said hydrocyclone desander for desanding and or said non-consumable or consumable mechanical solids filter for mechanical filtration; said fluid is then passed into said membrane unit is a membrane unit with a polymeric membrane filter where clean permeate is discharged and the concentrated fluid is recirculated to said pump.

In some embodiments, the present invention is a system for treating slop water comprising: FPSO fluid compartments; a pump; a hydrocyclone desander capable of desanding; a non-consumable or consumable mechanical solids filter capable of mechanical filtration; and multiple membrane units with a polymeric membrane filter; wherein fluid passed into said FPSO fluid compartments is pumped via said pump to either said hydrocyclone desander for desanding and or said non-consumable or consumable mechanical solids filter for mechanical filtration; said fluid is then passed into said membrane unit is a membrane unit with a polymeric membrane filter; and wherein water derived from said fluid from FPSO fluid compartments that is pumped via said pump to either said hydrocyclone desander for desanding and or said non-consumable or consumable mechanical solids filter for mechanical filtration; said fluid is then passed into said membrane unit is a membrane unit with a polymeric membrane filter where clean permeate is discharged and the concentrated fluid is recirculated to said FPSO fluid compartment.

In some embodiments, the present invention is a system for deck drainage treatment comprising: FPSO fluid compartments; a pump; a hydrocyclone desander capable of desanding; and or a non-consumable or consumable mechanical solids filter capable of mechanical filtration; and a membrane unit is a membrane unit with a polymeric membrane filter; wherein fluid passed into said FPSO fluid compartments said fluid is then capable of being pumped via said pump to either said hydrocyclone desander for desanding and or said non-consumable or consumable mechanical solids filter for mechanical filtration; said fluid is then passed into said membrane unit is a membrane unit with a polymeric membrane filter; and wherein water derived from said passing into said FPSO fluid compartments said fluid is then capable of being pumped via said pump to either said hydro-cyclone desander for desanding and or said non-consumable or consumable mechanical solids filter for mechanical filtration; said fluid Is then passed into said membrane unit is a membrane unit with a polymeric membrane filter where clean permeate is discharged and the concentrated fluid is recirculated to said FPSO fluid compartment.

In some embodiments, the present invention is a system for Enhanced Oil Recovery (EOR) Polymer Flood & Alkali Surfactant Polymer (ASP) treatment comprising; a separator or holding tank; a pump; a hydrocyclone desander capable of desanding; a non-consumable or consumable mechanical solids filter capable of mechanical filtration; and a membrane unit is a membrane unit with a polymeric membrane filter; wherein fluid passed into said separator or holding tank enters through- said intake valve and is treated for bulk oil, gas and solids separation; said fluid is then capable of being pumped via said pump to either said hydrocyclone desander for desanding and or said non-consumable or consumable mechanical solids filter for mechanical filtration; said fluid is then passed into said membrane unit is a membrane unit with a polymeric membrane filter; and wherein water derived from said passing into said separator or holding tank enters through said intake valve and is treated for bulk oil, gas and solids separation; said fluid is then capable of being pumped via said pump to either said hydrocyclone desander for desanding and or said non-consumable or consumable mechanical solids filter for mechanical filtration; said fluid is then passed into said membrane unit is a membrane unit with a polymeric membrane filter where clean permeate is discharged and the concentrated fluid is recirculated to said pump.

In several embodiments of the present invention, one aspect is to combine multiple technologies into one container: a pump; a hydrocyclone desander capable of desanding; a non-consumable or consumable mechanical solids filter capable of mechanical filtration; and a membrane unit is a membrane unit with a polymeric membrane filter. This will allow for the equipment to be ready for service faster than any other companies on the market. All other companies utilize modular equipment in this market which takes many hours to rig up and have ready for service. In several embodiments of the present invention, materials such as filters are reusable after cleaning.

### FPSO MEMBRANE SYSTEM SUBSUMMARY

In some embodiments, this tank, typically in the hull, will send water via a pump through a desanding hydrocyclone, and/or solids filter, and oil & solids removal membrane filter. The membrane is a crossflow technology which consist of recirculation loop from pump through the membrane and back into the tank in the hull of the ship. Crossflow is needed to keep solids contaminates away from membrane surface. Adding induced gas or dissolved gas can increase the agitation inside of the membrane as well as decrease the overall viscosity of the raw fluids, which will help in keeping the solids from attaching to the membrane surface.

### ACID STIMULATION AND COMPLETION TREATMENT SUBSUMMARY

In some embodiments, the fluids from a single well or multiple wells resulting from acid stimulation, or well completions, are sent to a three-phase separation vessel to release the lighter hydrocarbons gas phase, heavier hydrocarbons oil phase, and water and solids. The bulk of the heavy hydrocarbons and most of the light hydrocarbons will be removed in this vessel. The remaining hydrocarbons: typically range in concentrations from 200 mg/L to 5,000 mg/L depending on the emulsified state of the hydrocarbons and will be sent to a lower pressure multipurpose separations vessel (this can be either a pressure vessel or an atmospheric vessel). Different applications will have different amounts of oil in the water. The more the oil is emulsified, the more oil will be in the water after it leaves, for example, a 3-phase separator.

### PLATFORM MEMBRANE SYSTEM SUBSUMMARY

In some embodiments, this vessel, or tank, typically will have multiple compartments, including, but not limited to, an inlet compartment containing an inlet diffuser designed to further degas fluids, mix chemicals if they are required, a recirculation compartment, a clean water compartment and an oil compartment. The water phase from this vessel, or tank, will be pumped through a desanding hydrocyclone, and/or solids filter, and an oil & solids removal membrane filter.

In some embodiments, the membrane is a crossflow technology which consists of a circulation loop from a pump through a membrane and back into the suction of the pump. Crossflow is needed to keep solids contaminates away from membrane surface. Adding induced gas or dissolved gas will increase the agitation inside of the membrane as well as decrease the overall viscosity of the raw fluids, which will help in keeping the solids from attaching to the membrane surface.

### CONTAINERIZED TREATMENT SYSTEM SUBSUMMARY

In some embodiments of the present invention, one aspect of the present invention is to combine multiple technologies into one container; centrifugal pumps with variable speed drive, desander hydrocyclone and/or mechanical solids filters and oil & solids removing membranes. This will allow for the equipment to be ready for service faster than any other companies on the market. All other companies have modular equipment in this market which takes many hours to rig up and have ready for service.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 is a flow diagram of one embodiment of the present invention for acid and completion treatment.

FIG. 2 is a flow diagram of one embodiment of the present invention for FPSO Slop Water treatment.

FIG. 3 is a flow diagram of another embodiment of the present invention for deck drainage treatment.

FIG. 4 illustrates one embodiment of the present invention for EOR Polymer Flood & ASP treatment.

### DETAILED DESCRIPTION

One or more illustrative embodiments incorporating the invention disclosed herein are presented below. Applicant has created a revolutionary industrial water cleaning process, system and method.

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not .necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless or essentially meaningless, the definition should be taken from Webster's Dictionary, 11th Edition, 2008. Definitions and/or interpretations should not be incorporated from other patent applications, patents, or publications, related or not, unless specifically stated in this specification or if the incorporation is necessary for maintaining validity,.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

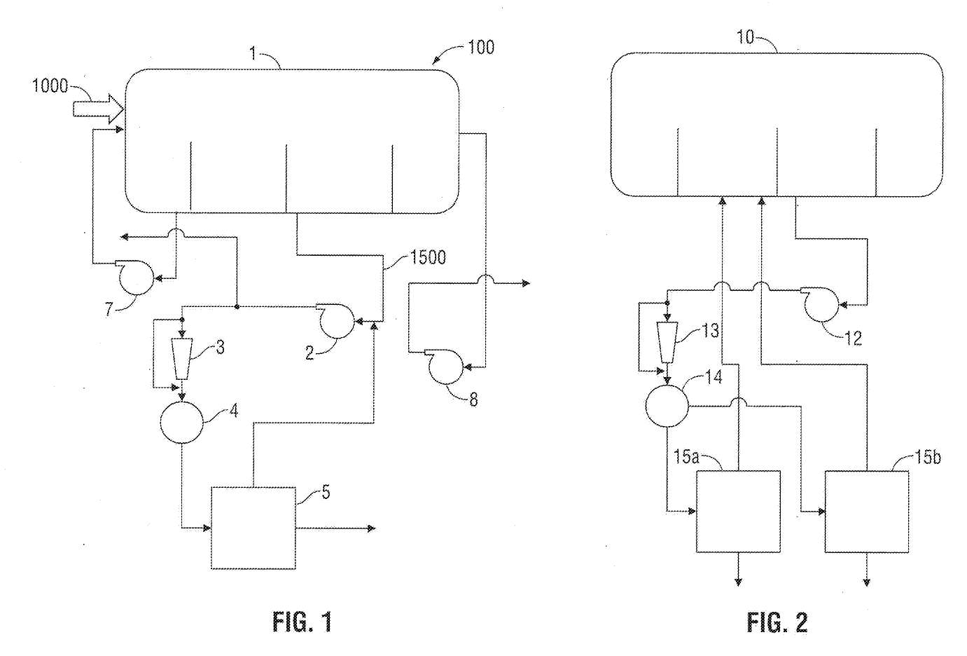

FIG. 1 illustrates one embodiment of the present invention 100 in a flow chart for acid and completion treatment. As shown, fluid 1000 can enter multicompartment separator 1. Multicompartment separator 1 is one known in the art for the separation of oil and gas separation fluid. Within multicompartment separator 1, the bulk of the free oil will separate by gravity where it will be skimmed by an oil skim pipe into the oil compartment, as is known in the art. In several embodiments, the water 1500 will weir under the weir plates from the last water compartment by pump 2 in to hydrocyclone desander 3 or mechanical solids removal unit 4. The remaining hydrocarbons typically range in concentrations from 200 mg/L to 5000 mg/L depending on the emulsified state of the hydrocarbons and will be sent to a lower pressure multipurpose separations vessel or tank (this can be either pressure vessel or atmospheric vessel). The hydrocyclone desander 3 or solids removal filter 4 will receive water containing solids and hydrocarbons; the hydrocarbons can be free or emulsified in the water.

Pump 2 is a pump as known in the art for pumping water, or fluids in an industrial cleaning process. In some instances, the water pumped by pump 2 can circumvent, hydrocyclone desander 3 and be pumped directly into non-consumable or consumable mechanical solids filter 4. In several embodiments, the water can be pumped into non-consumable or consumable mechanical solids filter 4 after being processed by hydrocyclone desander 3.

In many embodiments, desanding hydrocyclone 3, called a desander, offers the highest throughput-to-size ratio of any solids-removal equipment. Hydrocyclones operate by pressure drop. The feed, a mixture of liquids and solids, enters the cyclone through the volute inlet at the operating feed pressure. The change in flow direction forces the mixture to spin in a radial vortex pattern. Because of the angular acceleration of the flow pattern, centrifugal forces are imparted on the solid particles, forcing them toward the internal wail of the cone. The solids continue to spin in a radial vortex pattern, down the length of the cone, and discharge through the apex, creating the underflow stream. Because of cone convergence, the liquid flow is reversed and sent upward through the vortex finder to create the overflow stream. The solids that exit through the apex collect into an accumulation chamber and are periodically purged, while the overflow discharges continually.

In many embodiments, the water from non-consumable or consumable mechanical solids filter 4 will flow in to membrane unit 5. After being processed by membrane unit 5, the water can then be discharged and the water and oil that does not pass through membrane unit 5 can then be recirculated back to pump 2 to further be processed through hydrocyclone desander 3 or non-consumable or consumable mechanical solids filter 4, or both. Recirculation pump 7 recirculates fluids from multicompartment separator that may need chemical treatment and agitation to help break oil in water emulsions.

The membrane 5 is a crossflow technology which consists of a recirculation loop from pump 2 through the membrane 5 and back into the suction of the pump 2; occasionally this fluid will need to be replaced with fresh fluids from separation vessel or tank to reduce the oil content that has increased during the concentration process. Crossflow is needed to keep contaminates away from membrane surface 5. Adding gas induced gas or dissolved gas (as known in the art) will increase the agitation, inside of the membrane as well as decrease the overall viscosity of the raw fluids.

The water to be treated will flow into a vessel or tank typically will have multiple compartments including but not limited to an inlet compartment containing an inlet diffuser designed to further degas fluids, mix chemicals if they are required, a recirculation compartment, a clean water compartment and an oil compartment. The water phase from this vessel or tank will be pumped through a desanding hydrocyclone, and/or solids filter, and membrane filter.

Spiral wound elements consist of membranes, feed spacers, permeate spacers, and a permeate tube. The purpose of the feed spacer is to provide space for water to flow between the membrane surfaces, and to allow for uniform flow between the membrane leaves. Feed travels through the flow channels tangentially across the length of the element. Filtrate will then pass across the membrane surface into the permeate spacer, where it is carried down the permeate spacer towards the permeate tube. The feed then becomes concentrated a t the end of the element body. Filtration is any of various mechanical, physical operations that separate solids and oil from fluids.

Centrifugal pumps are the most commonly used kinetic-energy pump. Centrifugal force pushes the liquid outward from the eye of the impeller where it enters the casing. Differential head can be increased by turning the impeller faster, using a larger impeller, or by increasing the number of impellers. The impeller and the fluid being pumped are isolated from the outside by packing or mechanical seals. Shaft radial and thrust bearings restrict the movement of the shaft and reduce the friction of rotation.

FIG. 2 shows another embodiment of the present invention for FPSO slop water treatment. As shown, compromised water from FPSO fluid compartments 10 will be pumped by pump 12 in to hydrocyclone desander 13.

Pump 12 is a pump as known in the art for pumping water or fluids in an industrial cleaning process. In some instances, the water pumped by pump 12 can circumvent hydrocyclone desander 13 and be pumped directly into non-consumable or consumable mechanical solids filter 14. In several embodiments, the water can be pumped into non-consumable or consumable mechanical solids filter 14 after being processed by hydrocyclone desander 13. In many embodiments, solids removal vessel 14 will receive water containing solids and hydrocarbons; the hydrocarbons can be free or emulsified in the water.

In many embodiments, the water from non-consumable or consumable mechanical solids filter 14 will flow in to membrane unit 15a and or 15b. After being processed by membrane unit 15a and or 15b, the water can then be discharged and the water and oil that does not pass through membrane units 15a and 15b can then be recirculated back to fluid holding tank 10 to further be processed through hydrocyclone desander 13 and or non-consumable or consumable mechanical solids filter 14, or both.

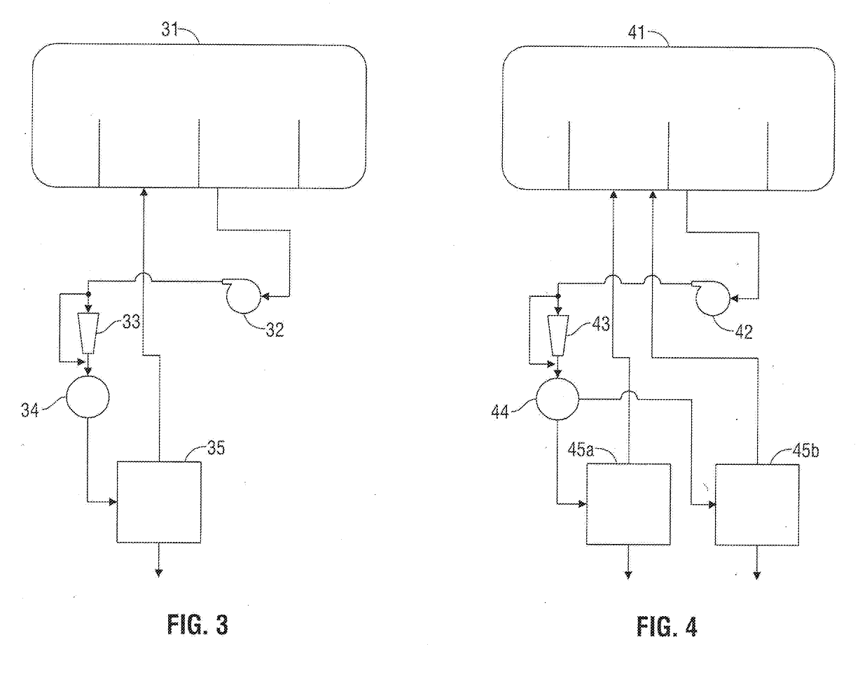

FIG. 3 illustrates one embodiment of the present Invention for deck drainage treatment. As shown, water from one of the deck drainage holding compartments 31 will be pumped by pump 32 into hydrocyclone desander 33 and/or non-consumable or consumable mechanical solids filter 34. The water will then How into membrane filtration unit 35. Water then passes through the membrane to be discharged and the water and oil that does not pass through the membrane will be recirculated into one of the multiple fluid holding compartments 31.

FIG. 4 illustrates one embodiment of the present invention for EOR Polymer Flood & ASP treatment. As shown, water from one of the separators or holding tank 41 will be pumped by pump 42 into hydrocyclone desander 43 and or non-consumable or consumable mechanical solids filter 44. The water will then flow into membrane unit 45. From the membrane unit 45, the water that passes through the membrane will be discharged and the water and oil that does not pass through the membrane will be recirculated into one of the multiple fluid holding compartments 41.

As shown in FIGS. 1-4, the fluids from single or multiple wells from oil and gas production are sent to a three-phase separation vessel 1 to release the lighter hydrocarbons gas phase, heavier hydrocarbons oil phase, and water and solids. The bulk of the heavy hydrocarbons and roost of the light hydrocarbons will be removed in this vessel 1.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

What is claimed is the following:

1. A system for acid and completion treatment comprising:
a multicompartment separator or tank capable of treatment for separation with an intake valve;
a pump;
a hydrocyclone desander capable of desanding and or a non-consumable or consumable mechanical solids filter capable of mechanical filtration; and
a membrane unit that is a membrane unit with a polymeric membrane filter; wherein
fluid passed into said multicompartment separator enters through said intake valve and is treated for separation; said fluid is then capable of being pumped via said pump to either said hydrocyclone desander for desanding and or to said non-consumable or consumable mechanical solids filter for mechanical filtration; said fluid is then passed into said membrane unit with a polymeric membrane filter; and wherein
water derived from said passing into said multicompartment separator enters through said intake valve and is treated for separation; said fluid is then capable of being pumped via said pump to either said hydrocyclone desander for desanding or said non-consumable consumable mechanical solids filter for mechanical filtration; said fluid is then passed into said a membrane unit with a polymeric membrane filter and is discharged and additional non-treated fluid is recirculated to said pump and or vessel or tank.

2. The system for acid and completion treatment of claim 1 further comprising:
said pump;
said hydrocyclone desander capable of desanding; and or
said non-consumable or consumable mechanical solids filter capable of mechanical filtration; and
said membrane unit with a polymeric membrane filter; encapsulated as a single work unit.

3. A system for treating slop water comprising:
FPSO fluid compartments;
a pump;
either a hydrocyclone desander capable of desanding and or a non-consumable or consumable mechanical solids filter capable of mechanical filtration; and
a membrane unit with a polymeric membrane filter; wherein
fluid passed into said FPSO fluid compartments is pumped via said pump to either said hydrocyclone desander for desanding and or to said non-consumable or consumable mechanical solids filter for mechanical filtration; said fluid is then passed into said membrane unit with a polymeric membrane filter; and wherein
water derived from said fluid from FPSO fluid compartments that is pumped via said pomp to either said hydrocyclone desander for desanding and or to said non-consumable or consumable mechanical solids filter for mechanical filtration; said fluid is then passed into said membrane unit with a polymeric membrane filter and is discharged and additional non-treated fluid is recirculated to said FPSO fluid compartment.
4. The system for treating slop water of claim 3 further comprising:
said pump;
said hydrocyclone desander capable of desanding; and or
said non-consumable or consumable mechanical solids filter capable of mechanical filtration; and
said multiple membrane units are membrane units with a polymeric membrane filter encapsulated as a single work unit.
5. A system for deck drainage treatment comprising:
FPSO fluid compartments;:
a pump;
a hydrocyclone desander capable of desanding;
a non-consumable or consumable mechanical solids filter capable of mechanical filtration; and
a membrane unit that is a membrane unit with a polymeric membrane filter; wherein
fluid is passed into said FPSO fluid compartments; said fluid is then capable of being pumped via said pump to either said hydrocyclone desander for desanding or to said non-consumable consumable mechanical solids filter for mechanical filtration; said fluid is then passed into said membrane unit with a polymeric membrane filter; and wherein
water derived from said passing into said FPSO fluid compartments; is then capable of being pumped via said pump to either said hydrocyclone desander for desanding or to said non-consumable or consumable mechanical solids filter for mechanical filtration; said fluid is then passed into said membrane unit with a polymeric membrane filter is discharged and additional fluid and is recirculated to said pump.

6. The system for deck drainage treatment of claim 5 further comprising:
said pump;
said hydrocyclone desander capable of desanding;
said non-consumable or consumable mechanical solids filter capable of mechanical filtration; and
said membrane unit with a polymeric membrane filter; encapsulated as a single work unit container.

7. A system for EOR Polymer Flood & ASP treatment comprising:
a separator or holding tank;
a pump;
a hydrocyclone desander capable of desanding;
a non-consumable or consumable mechanical solids filter capable of mechanical filtration; and
a membrane unit that is a membrane unit with a polymeric membrane filter; wherein
fluid passed into said separator or holding tank enters through said intake valve and is treated for separation; said fluid is then capable of being pumped via said pump to either said hydrocyclone desander for desanding or to said non-consumable or consumable mechanical solids filter for mechanical filtration; said fluid is then passed into said membrane unit with a polymeric membrane filter; and wherein
water derived from said passing into said separator or holding tank enters through said intake valve and is treated for separation; said fluid is then capable of being pumped via said pump to either said hydrocyclone desander for desanding and or said non-consumable or consumable mechanical solids filter for mechanical filtration; said fluid is then passed into said membrane unit with a polymeric membrane filter and is discharged and additional fluid is recirculated to said separator or holding tank.

8. The system for EOR Polymer Flood & ASP treatment of claim 7 further comprising:
said pump;
said hydrocyclone desander capable of desanding;
said non-consumable or consumable mechanical solids filter capable of mechanical filtration; and
said membrane unit with a polymeric membrane filter, encapsulated as a single work unit.
9. A method for acid and completion treatment comprising:
passing fluid into said multicompartment separator through an intake valve; treating for separation;
pumping said fluid to a hydrocyclone desander for desanding;
pumping said fluid to a non-consumable or consumable mechanical solids filter for
mechanical filtration; and
passing said fluid into a membrane unit that is a membrane unit with a polymeric membrane filter.

10. A method for treating slop water comprising:
pumping fluid from FPSO fluid compartments into a hydrocyclone desander for desanding; and
passing fluid from said desander into a membrane unit that is a membrane unit with a polymeric filter.

11. A method for treating slop water comprising the steps of:
pumping fluid from FPSO fluid compartments into a solid filter for non-consumable or consumable mechanical filtration; and
passing fluid from said desander into a membrane unit that, is a membrane unit with a polymeric filter.

12. A method for deck drainage treatment comprising the steps of:
pumping fluid from FPSO fluid compartments treated for separation into a hydrocyclone desander for desanding; and
passing said fluid into a membrane unit that, is a membrane unit with a polymeric membrane filter for further filtration.
13. A method for EOR Polymer Flood & ASP treatment comprising the steps of:
pumping a fluid from a separator or holding tank for separation into a hydrocyclone desander for desanding; and
passing said fluid into a membrane unit that is a membrane unit with a polymeric membrane filter.
